(19) United States
(12) Patent Application Publication
(10) Pub. No.: US 2026/0111910 A1
(43) Pub. Date: Apr. 23, 2026

(54) ENTERPRISE ARCHITECTURE GOVERNANCE AUTOMATION

(71) Applicant: American Express Travel Related Services Company, Inc., New York, NY (US)

(72) Inventors: Shoma Samir Chakravarty, Chevy Chase, MD (US); Anup K. Verma, Weston, FL (US)

(21) Appl. No.: 18/921,397

(22) Filed: Oct. 21, 2024

(51) Int. Cl. G06Q 30/018

(52) U.S. Cl. CPC G06Q 30/018

(57) ABSTRACT

Disclosed are various embodiments for enterprise architecture governance automation. A system is provided which can use a computing device to obtain health data for an application. The computing device can further obtain one or more health standards. Next, the computing device can analyze the health data based at least in part on the one or more health standards and determine a health score based at least in part on the analysis of the health data. Then, the computing device can generate a scorecard for the application based at least in part on the health score.

### BACKGROUND

Governance of application architecture in large enterprises is traditionally done via creation of prescriptive documents and their subsequent enforcement through manual review processes. Such a process is error-prone due to the reviewing team often not possessing expert knowledge of the nuances of each system that is reviewed. Reviews can also be inconsistent based on the capability of the reviewer(s) at the time they review. Further, as an enterprise architecture scales to larger sizes, more human resources are required to perform manual reviews of system architecture, which results additional costs.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of the application described in FIG. 3 according to various embodiments of the present disclosure.

FIG. 5 is a sequence diagram illustrating interactions between various components of the network environment of FIG. 1 according to various embodiments of the present disclosure.

### DETAILED DESCRIPTION

Disclosed are various approaches for enterprise architecture governance automation. Various embodiments of the present disclosure provide an automated solution which enables systematic scanning and scoring of applications for compliance against predefined standards to systematically generate a “well-architected” scorecard, or representation of how well said standards are met. Governance of application architecture in large enterprises is traditionally done via creation of prescriptive documents and their subsequent enforcement through manual review processes.

In scenarios where manual solutions are utilized, a centralized Architecture governing body often prescribes documentation templates for required architecture artifacts. Software delivery teams fill out and submit these artifacts to the governing body either as document attachments in a centralized repository (e.g., Microsoft SharePoint), or provide links to documentation created on a collaboration tool (e.g., Confluence). In either scenario, the completeness and correctness of these artifacts is assessed only through manual processes which typically takes the form of a meeting between representatives of the governing body and members of the application delivery team. The manual processing can be extremely human resource intensive, leading to scalability and cost issues. Further, manual processing is error-prone since a central team of reviewers often do not possess expert knowledge of the nuances of each system they review. As a result, the reviews may be inconsistent because the outcome of each review is dependent on the capability of the reviewer and may vary from one review committee to another.

Although some software has been used to automate various process, no current state of the art takes an automated approach to scanning and scoring architecture compliance. Specifically, no competitors automate sourcing of data from application health domains; automate scanning and performing analysis of architecture artifacts (e.g., architecture diagrams, documentation, decision records, etc.) to generate a health score; and prescribe specifications for how architecture artifacts (e.g., architecture diagrams, documentation, decision records, etc.) should be formatted to aid in automation.

To address these problems, various embodiments of the present disclosure automate the governance of enterprise architecture. By using artificial intelligence (AI), the present invention can automate data mining, analysis, and scoring, to manage enterprise systems. The system can prescribe requirements for obtaining architecture artifacts from the various components of an enterprise's computer infrastructure and data management. Then, the system can automatically generate architecture artifacts according to the prescribed requirements and use these artifacts to analyze and score systems. In some embodiments, the system can proof the artifacts before analysis to provide an opportunity for feedback to a user. In addition to generating the artifacts, the system can analyze the artifacts to generate a scorecard, or other representation of the health and compliance of different components of the architecture.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

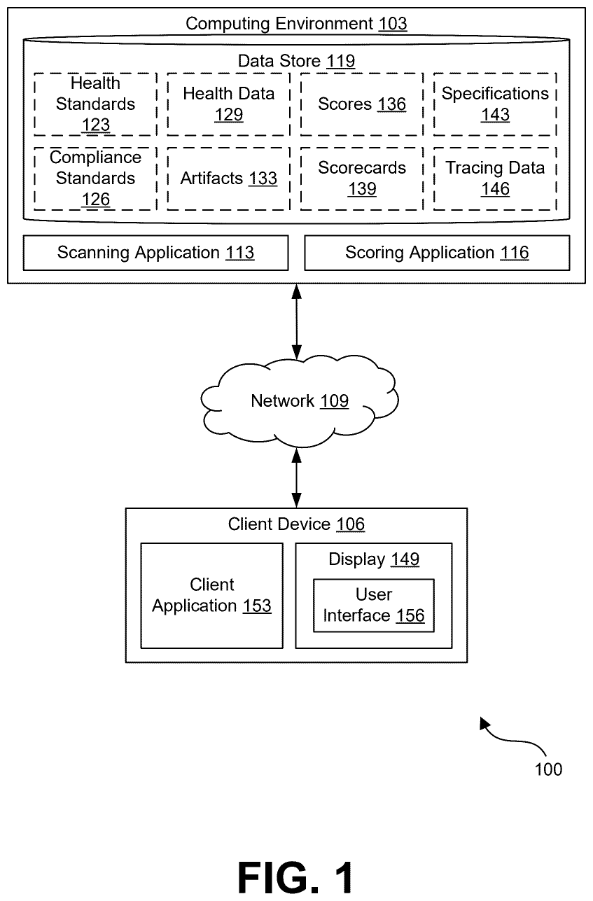

With reference to FIG. 1, shown is a network environment 100 according to various embodiments. The network environment 100 can include a computing environment 103 and a client device 106 which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a scanning application 113 and a scoring application 116, as well as other applications, services, processes, systems, engines, or functionality not discussed in detail herein.

The scanning application 113 can be executed to pull data from various sources across an enterprise's architectural scheme, prescribe rules for the generation of artifacts, generate artifacts corresponding to the various sources, and obtain data for further analysis. The scanning application 113 can utilize various forms of machine learning, such as large language models (LLMs), to extract data from multiple systems. In addition, the scanning application 113 can convert the data to one standardized format which can be processed by the scoring application 116.

The scoring application 116 can be executed to analyze the data obtained by the scanning application 113. An enterprise can have operational health and/or compliance standards by which they are required to operate. The scoring application 116 can reference these standards when analyzing the data obtained by the scanning application 113 in order to produce a scorecard which has relevant information for the enterprise.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include health standards 123, compliance standards 126, health data 129, artifacts 133, scores 136, scorecards 139, specifications 143, tracing data 146, and potentially other data.

The health standards 123 can represent one or more metrics, measures, rules, or values by which the health of an architectural element can be evaluated. Health standards 123 can be dictated by internal organizational policies or, in some embodiments, by an external organization or regulatory or governing body. In some examples, health standards 123 can include performance metrics such as response time, incident counts, error rates, availability, server or memory usage, request rate, etc.

The compliance standards 126 can represent one or more metrics, measures, rules, or values by which the compliance of a system's architecture can be evaluated. In many instances, there are external and internal policies, regulations, and best practices with which an application must comply. Compliance standards 126 can include standards for architectural compliance, security, data management, reliability, performance, scalability, cost, customer experience, and various other fields which may be regulated in an enterprise.

The health data 129 can represent information and metrics related to specific applications, services, and other elements in an architectural environment. The health data 129 can include information such as performance outcomes, history, development, and quality of performance of an architectural element over a time period of interest.

The artifacts 133 can represent a specification of information that is used or produced by a software development process or by deployment and operation of a system. For example, an artifact 133 can represent a model, a diagram, source code file, documentation (e.g., in the form of a file, web page, etc.), database tables, scripts, etc. Artifacts 133 can include markdown and structured diagram artifacts, as well as various other formats. A markdown artifact 133 can include fields for creation date, date of last update, authors, status, section titles, content, and other various fields. In some examples, a structured diagram artifact 133 can be a standardized format artifact 133 which can be generated in the form of a diagram or other visual.

The scores 136 can represent a variety of different measures or calculations of the performance of an architectural element in a specified context. For example, a score 136 can represent a health or compliance score for an application based at least in part on health data 129, health standards 123, compliance standards 126, or other data. In some examples, the scores 136 can include a presence score, or a measure of whether a particular document is required to be created for a certain type of application. In another example, the scores 136 can include a completeness score, or measure of whether a document or diagram contains the sections and relevant content required by the standards for such a document or diagram. Similarly, in some examples, the scores 136 can include a correctness score, or measure of whether the content in a document or diagram meets the standards set forth for the particular document or diagram.

The scorecards 139 can represent an output of the scoring application 116. A scorecard 139 can include one or more scores 136 which have been calculated for various aspects of an architectural element. In some examples, a scorecard 139 can be a visual diagram of the scores 136, presenting data in the form of a graph or chart. In some embodiments, the scorecards 139 can present scores 136 for compliance, security, reliability, performance, maintainability, scalability, data and API, cost, customer experience, regulatory health, or other measures.

The specifications 143 can include one or more set of rules and standards for the generation of artifacts 133. The specifications 143 can include formatting rules, content rules, style rules, and other specifications for the generation of artifacts 133. In some examples, the specifications 143 can be determined and prescribed by the scanning application 113.

The tracing data 146 can include recorded data about the execution of a software program or other element in the architectural environment. The tracing data 146 can be used in combination with the health data 129 to cross-check a score 136 and verify accuracy.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 149, such as liquid crystal displays (LCDs), gas plasma-based flat panel displays, organic light emitting diode (OLED) displays, electrophoretic ink (“E-ink”) displays, projectors, or other types of display devices. In some instances, the display 149 can be a component of the client device 106 or can be connected to the client device 106 through a wired or wireless connection.

The client device 106 can be configured to execute various applications such as a client application 153 or other applications. The client application 153 can be executed in a client device 106 to access network content served up by the computing environment 103 or other servers, thereby rendering a user interface 156 on the display 149. To this end, the client application 153 can include a browser, a dedicated application, or other executable, and the user interface 156 can include a network page, an application screen, or other user mechanism for obtaining user input. The client device 106 can be configured to execute applications beyond the client application 153 such as email applications, social networking applications, word processors, spreadsheets, or other applications.

Next, a general description of the operation of the various components of the network environment 100 is provided. To begin, a user can initiate a request for a scorecard 139 using a client device 106. In some examples, a user such as an information technology (IT) specialist or an architecture engineer or other professional may require a scorecard 139 for one or more applications, services, or systems in an architectural environment. Thus, the user can interact with a user interface 156 of a client device 106 in order to submit a request for a scorecard 139. The request can be received by the scoring application 116 which can extract information about the particular application(s), service(s), or system(s) for which the scorecard 139 must be generated. Then, the scoring application 116 can send a data request to the scanning application 113.

Once the scanning application 113 receives a request for data, the scanning application 113 can begin extracting data about the particular application(s), service(s), or system(s) identified in the request. The scanning application 113 can also prescribe specifications 143 for the generation of artifacts 133 based at least in part on the application(s), service(s), or system(s). Using these specifications 143 as guidelines, the scanning application 113 can then generate one or more artifacts 133. Next, the scanning application 113 can obtain various data about the application(s), service(s), or system(s) from a variety of sources. This data can include health data 129, tracing data 146, or other data. In some embodiments, the scanning application 113 can obtain the data from a data store 119, from the artifacts 133, or from the application(s), service(s), or system(s) themselves.

Next, the scanning application 113 can obtain standards. Depending on the request for the scorecard 139 and the type of scorecard 139 needed, the scanning application 113 can obtain standards such as compliance standards 126 and/or health standards 123. The scanning application 113 can combine the various data and standards into one standardized format data packet and send the data packet to the scoring application 116.

The scoring application 116 can receive the data packet, extract the data and standards, and analyze the data to generate a scorecard 139. In some examples, the scoring application 116 can compare the data to the standards. The scoring application 116 can compare the artifacts 133 and health data 129 to tracing data 146. By referencing the standards, and in some examples, the tracing data 146, the scoring application 116 can calculate one or more scores 136 for the particular application(s), service(s), or system(s) to be evaluated in the scorecard 139. Once the scores 136 have been calculated, the scoring application 116 can generate the scorecard 139 and return it to the client application 153.

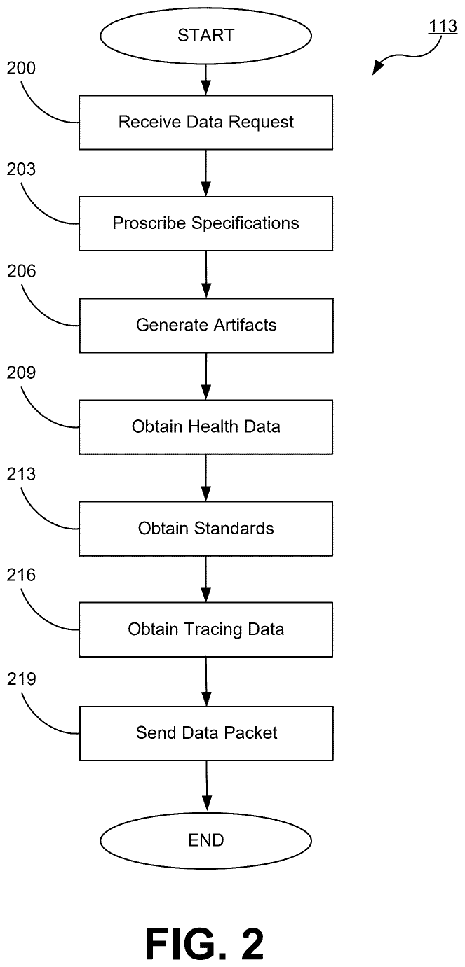

Referring next to FIG. 2, shown is a flowchart that provides one example of the operation of a portion of the scanning application 113. The flowchart of FIG. 2 provides merely an example of the many different types of functional arrangements that can be employed to implement the operation of the depicted portion of the scanning application 113. As an alternative, the flowchart of FIG. 2 can be viewed as depicting an example of elements of a method implemented within the network environment 100.

Beginning with block 200, the scanning application 113 can be executed to receive a data request. In some examples, the scanning application 113 can receive a request for data about particular application(s), service(s), or system(s). Based at least in part on the request, the scanning application 113 can identify the application(s), service(s), or system(s) of interest and being extracting data from those sources. In some examples, the scanning application 113 can receive such a request from a client application 153, the scoring application 116, or another application in the network environment 100.

Next, at block 203, the scanning application 113 can be executed to prescribe one or more specifications 143. The scanning application 113 can prescribe one or more specifications 143 for the generation of various artifacts 133. For example, the scanning application 113 can prescribe the format and contents for artifacts 133. The scanning application 113 can prescribe specifications 143 based at least in part on the data request received at block 200. For example, the scanning application 113 can prescribe the contents of a particular artifact 133 based at least in part on the application identified in the data request.

Continuing to block 206, the scanning application 113 can be executed to generate one or more artifacts 133. In some examples, the scanning application 113 can generate one or more artifacts 133 related to the application, service, or system identified in the data request from block 200. The scanning application 113 can generate the one or more artifacts 133 based at least in part on the specifications 143 prescribed at block 203.

Next, at block 209, the scanning application 113 can be executed to obtain health data 129. The scanning application 113 can obtain the health data 129 pertaining to the relevant application, service, or system identified in the data request from block 200. The data request can also include instructions for which health data 129 the scanning application 113 should obtain. In some examples, the scanning application 113 can obtain the health data 129 based at least in part on the artifacts 133 generated at block 206.

Continuing to block 213, the scanning application 113 can be executed to obtain standards. The scanning application 113 can obtain health standards 123, compliance standards 126, or other standards which may apply to the application, service, or system identified in the data request from block 200. In some examples, the scanning application 113 can obtain these standards based at least in part on the artifacts 133 generated at block 206 or the specifications 143 prescribed at block 203. The scanning application 113 can obtain the standards from a data store 119 or from another application, service, or system in the network environment 100.

At block 216, the scanning application 113 can be executed to obtain tracing data 146. The scanning application 113 can obtain tracing data 146 from the application, service, or system identified in the data request from block 200. In some examples, the scanning application 113 can obtain tracing data 146 in response to receiving the data request.

Next, at block 219, the scanning application 113 can be executed to send a data packet. The data packet can be representative of a collection of the artifacts 133, health data 129, standards, and tracing data 146 in a standardized format. The scanning application 113 can send the data packet once the various components have been collected. In some examples, the scanning application 113 can send the data packet to a scoring application 116 for further processing. Once block 219 has completed, the process depicted by the flowchart of FIG. 2 can come to an end.

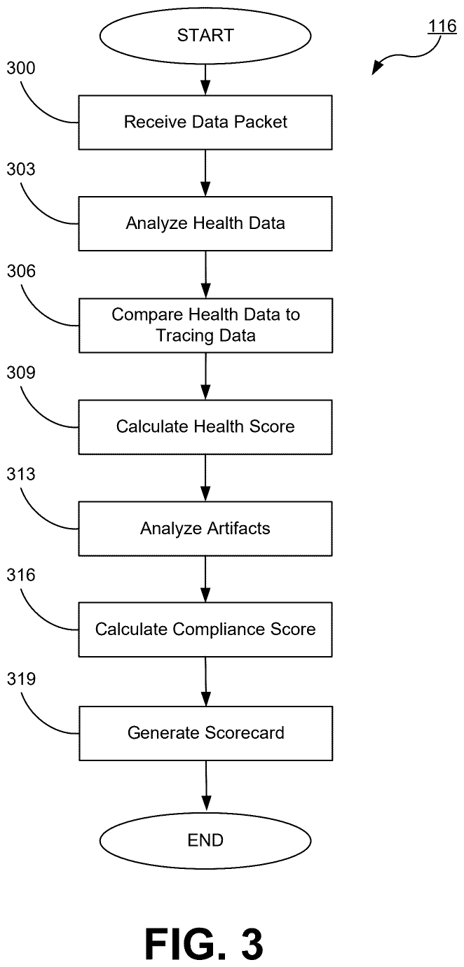

Referring next to FIG. 3, shown is a flowchart that provides one example of the operation of a portion of the scoring application 116. The flowchart of FIG. 3 provides merely an example of the many different types of functional arrangements that can be employed to implement the operation of the depicted portion of the scoring application 116. As an alternative, the flowchart of FIG. 3 can be viewed as depicting an example of elements of a method implemented within the network environment 100.

Beginning with block 300, the scoring application 116 can be executed to receive a data packet. In some examples, the scoring application 116 can receive the data packet from the scanning application 113 as described at block 219 of FIG. 2. The data packet can include artifacts 133, health data 129, standards, tracing data 146, or other data. In some embodiments, the scoring application 116 can receive a data packet in response to sending a request for data.

Next, at block 303, the scoring application 116 can be executed to analyze health data 129. The scoring application 116 can obtain the health data 129 from the data packet received at block 300. In some embodiments, the scoring application 116 can analyze the health data 129 by comparing the health data 129 to one or more health standards 123. The scoring application 116 can analyze the health data 129 for accordance with the health standards 123 as well as for abnormalities or anomalies.

Continuing to block 306, the scoring application 116 can be executed to compare health data 129 to tracing data 146. In some examples, the scoring application 116 can compare the health data 129 obtained from the data packet at block 300 and analyzed at block 303 to tracing data 146 obtained from the data packet. The tracing data 146 can correspond to the same application, service, or system to which the health data 129 corresponds. The scoring application 116 can compare the health data 129 to the tracing data 146 to verify accuracy, check for discrepancies, and fill in any gaps in the data.

Next, at block 309, the scoring application 116 can be executed to calculate a health score. Based at least in part on the analysis of the health data 129 at block 303, the scoring application 116 can calculate a health score for the corresponding application, service, or system. In some examples, the scoring application 116 can calculate a health score based at least in part on the comparison of the health data 129 to the tracing data 146 from block 306.

Continuing to block 313, the scoring application 116 can be executed to analyze one or more artifacts 133. The scoring application 116 can obtain one or more artifacts 133 from the data packet received at block 300. In some examples, the scoring application 116 can analyze the artifacts 133 by comparing the artifacts 133 to one or more compliance standards 126. The artifacts 133 can be analyzed by the scoring application 116 to determine compliance with the compliance standards 126 as well as for abnormalities or anomalies. In some examples, the artifacts 133 can be compared to the health data 129 to check for discrepancies and verify accuracy.

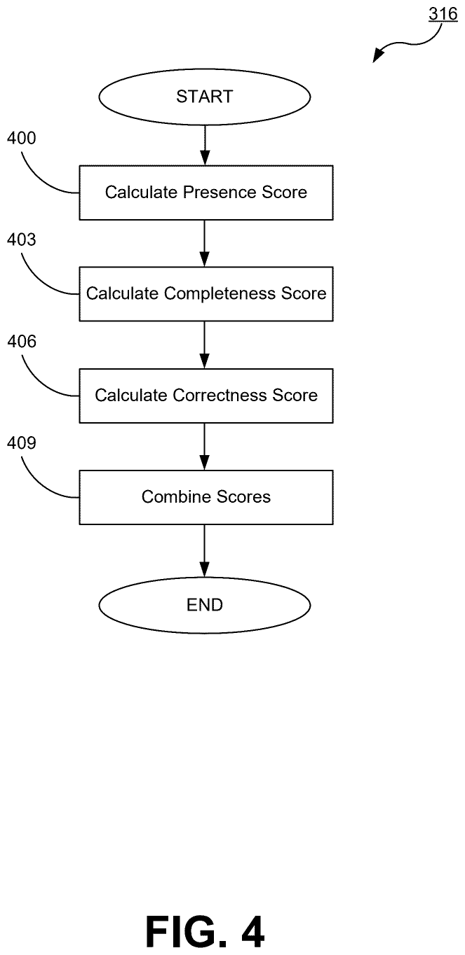

At block 316, the scoring application 116 can be executed to calculate a compliance score. In some examples, the scoring application 116 can calculate a compliance score based at least in part on the analysis of the one or more artifacts 133 at block 313. The scoring application 116 can use one or more factors to calculate a compliance score for the application, service, or system implicated in the data packet from block 300. For example, the scoring application 116 can calculate the compliance score based at least in part on the artifacts 133 and the compliance standards 126 from the data packet. The scoring application 116 can calculate the compliance score based at least in part on a plurality of other scores, as described further in the description of FIG. 4.

Next, at block 319, the scoring application 116 can be executed to generate a scorecard 139. The scoring application 116 can generate a scorecard 139 based at least in part on the data packet received at block 300. In some examples, the scorecard 139 corresponds to the application, service, or system for which the data packet was created. The scorecard 139 can be generated to include one or more scores 136 which the scoring application 116 has calculated. For example, the scoring application 116 can generate the scorecard 139 based at least in part on the health score from block 309 and the compliance score from block 316. The scoring application 116 can include each individual score 136 in the scorecard 139 as well as a visual representation of the scores 136. Once block 319 has completed, the flowchart of FIG. 3 can come to an end.

Referring next to FIG. 4, shown is a flowchart that provides one example of the operation of a portion of the scoring application 116, specifically block 316. The flowchart of FIG. 4 provides merely an example of the many different types of functional arrangements that can be employed to implement the operation of the depicted portion of the scoring application 116. As an alternative, the flowchart of FIG. 4 can be viewed as depicting an example of elements of a method implemented within the network environment 100.

Beginning with block 400, the scoring application 116 can be executed to calculate a presence score. As part of the calculation of the compliance score from block 316, the scoring application 116 can calculate a presence score based at least in part on the artifacts 133 analyzed at block 313 and compliance standards 126. In some examples, the scoring application 116 can calculate a presence score based at least in part on whether certain artifacts 133 required by the compliance standards 126 are present in the data packet.

Next, at block 403, the scoring application 116 can be executed to calculate a completeness score. The scoring application 116 can calculate a completeness score based at least in part on the artifacts 133 analyzed at block 313 and compliance standards 126. In some examples, the scoring application 116 can calculate a completeness score based at least in part on whether contents of the artifacts 133 required by the compliance standards 126 are complete in the data packet.

At block 406, the scoring application 116 can be executed to calculate a correctness score. The scoring application 116 can calculate a correctness score based at least in part on the artifacts 133 analyzed at block 313 and compliance standards 126. In some examples, the scoring application 116 can calculate a correctness score based at least in part on whether the contents of the artifacts 133 required by the compliance standards 126 are correct in the data packet.

Next, at block 409, the scoring application 116 can be executed to combine scores. The scoring application 116 can combine one or more of the presence score from block 400, the completeness score from block 403, and the correctness score from block 406. In some examples, the result of the combination of these scores comprises the compliance score from block 316 in FIG. 3. Once block 409 has completed, the process depicted by the flowchart of FIG. 4 can come to an end.

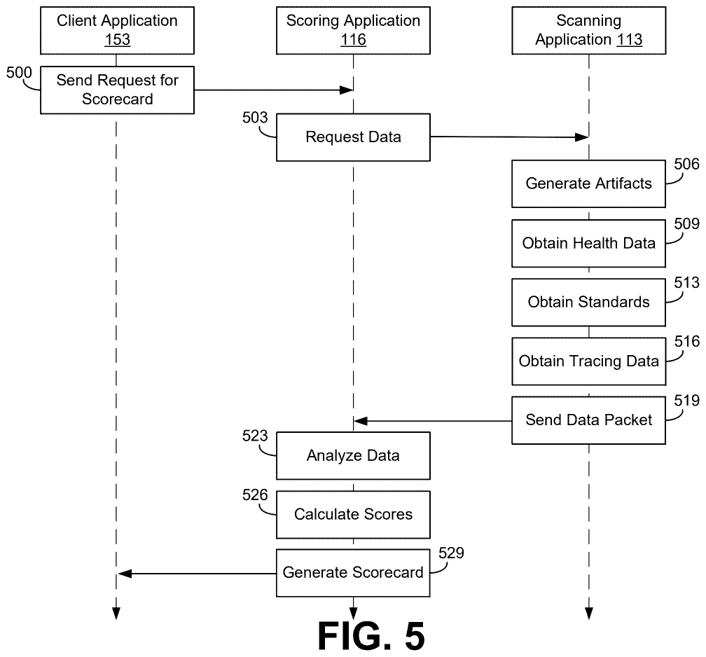

Moving on to FIG. 5, shown is a sequence diagram that provides at least one example of the interactions between the client application 153, the scanning application 113, and the scoring application 116. The sequence diagram of FIG. 5 provides merely an example of the many different types of functional arrangements that can be employed by the scanning application 113, the scoring application 116, and the client application 153. As an alternative, the sequence diagram of FIG. 5 can be viewed as depicting examples of elements of one or more method implemented within the network environment 100.

Beginning at block 500, the client application 153 can be executed to send a request for a scorecard 139. The request for a scorecard 139 can identify an application, service, or system for which the scorecard 139 is needed. In some examples, the client application 153 can generate the request for a scorecard 139 based at least in part on a user input.

Next, at block 503, the scoring application 116 can send a request for data to the scanning application 113. In some examples, the request for data can include the identity of the application, service, or system for which the data is needed. The scoring application 116 can generate the request based at least in part on the request for a scorecard 139 from the client application 153 at block 500.

Moving to block 506, the scanning application 113 can generate one or more artifacts 133, as previously described in block 206 of FIG. 2. Next, at block 509, the scanning application 113 can obtain health data 129, as previously described in block 209 of FIG. 2. Next, at block 513, the scanning application 113 can obtain standards, as previously described in block 213 of FIG. 2. Next, at block 516, the scanning application 113 can obtain tracing data 146, as previously described in block 216 of FIG. 2. Then, at block 519, the scanning application 113 can send a data packet, as previously described in block 219 of FIG. 2.

Next, at block 523 the scoring application 116 can analyze data, as previously described in blocks 303 and 313 of FIG. 3. After analyzing the data, at block 526, the scoring application 116 can calculate scores, as previously described in blocks 309 and 316 of FIG. 3 and blocks 400, 403, and 406 of FIG. 4. Finally, at block 529, the scoring application 116 can generate a scorecard 139 as previously described in block 319 of FIG. 3. Subsequently, the sequence diagram of FIG. 5 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a plurality of computing devices, each computing device comprising a processor and a memory; and
a first set of machine-readable instructions stored in the memory of at least one computing device of the plurality of computing devices that, when executed by the processor of the at least one computing device, cause the at least one computing device to at least:
receive health data for an application;
analyze the health data based at least in part on one or more health standards;
determine a health score based at least in part on an analysis of the health data; and
generate a scorecard for the application based at least in part on the health score.

2. The system of claim 1, wherein a second set of machine-readable instructions further causes at least one of the plurality of computing devices to at least:
generate one or more architecture artifacts;
analyze the one or more architecture artifacts to obtain the health data; and
send the health data to the first set of machine-readable instructions.

3. The system of claim 2, wherein the second set of machine-readable instructions further causes at least one of the plurality of computing devices to at least prescribe one or more specifications for generating the one or more architecture artifacts.

4. The system of claim 2, wherein the first set of machine-readable instructions further causes the at least one computing device to at least:
analyze the one or more architecture artifacts based at least in part on one or more compliance standards; and
determine a compliance score based at least in part on an analysis of the architecture artifacts.

5. The system of claim 4, wherein the first set of machine-readable instructions further causes the at least one computing device to at least generate the scorecard for the application based at least in part on the compliance score.

6. The system of claim 4, wherein the first set of machine-readable instructions which causes the at least one computing device to determine the compliance score further causes the at least one computing device to at least:
calculate a presence score;
calculate a completeness score;
calculate a correctness score; and
combine the presence score, the completeness score, and the correctness score to determine the compliance score.

7. The system of claim 1, wherein the first set of machine-readable instructions which causes the at least one computing device to determine the health score further causes the at least one computing device to at least:
compare the health data to tracing data for the application; and
calculate a health score based at least in part on a comparison of the health data and the tracing data.

8. A method, comprising:
receiving, by at least one computing device of a plurality of computing devices, health data for an application;
analyzing, by the at least one computing device, the health data based at least in part on one or more health standards;
determining, by the at least one computing device, a health score based at least in part on an analysis of the health data; and
generating, by the at least one computing device, a scorecard for the application based at least in part on the health score.

9. The method of claim 8, further comprising:
generating, by at least one computing device of the plurality of computing devices, one or more architecture artifacts; and
analyzing, by the at least one computing device, the one or more architecture artifacts to obtain the health data.

10. The method of claim 9, further comprising prescribing, by the at least one computing device, one or more specifications for generating the one or more architecture artifacts.

11. The method of claim 9, further comprising:
analyzing, by the at least one computing device, the one or more architecture artifacts based at least in part on one or more compliance standards; and
determining, by the at least one computing device, a compliance score based at least in part on an analysis of the architecture artifacts.

12. The method of claim 11, further comprising generating, by the at least one computing device, the scorecard for the application based at least in part on the compliance score.

13. The method of claim 11, wherein determining the compliance score further comprises at least:
calculating, by the at least one computing device, a presence score;
calculating, by the at least one computing device, a completeness score;
calculating, by the at least one computing device, a correctness score; and
combining, by the at least one computing device, the presence score, the completeness score, and the correctness score to determine the compliance score.

14. The method of claim 8, wherein determining the health score further comprises:
comparing, by the at least one computing device, the health data to tracing data for the application; and
calculating, by the at least one computing device, a health score based at least in part on a comparison of the health data and the tracing data.

15. A system, comprising:
a plurality of computing devices, each computing device comprising a processor and a memory; and
a first set of machine-readable instructions stored in the memory of at least one computing device of the plurality of computing devices that, when executed by the processor of the at least one computing device, cause the at least one computing device to at least:
receive one or more architecture artifacts corresponding to an application;
analyze the one or more architecture artifacts to obtain health data corresponding to the application;
compare the health data to one or more health standards;
compare the architecture artifacts to one or more compliance standards; and
generate a scorecard for the application based at least in part on a comparison of the health data and a comparison of the architecture artifacts.

16. The system of claim 15, wherein a second set of machine-readable instructions further causes the at least one computing device to at least:
prescribe one or more specifications for generating the one or more architecture artifacts; and
generate the one or more architecture artifacts based at least in part on the one or more specifications.

17. The system of claim 15, wherein the first set of machine-readable instructions further causes the at least one computing device to at least:
calculate a compliance score based at least in part on the comparison of the architecture artifacts; and
generate the scorecard based at least in part on the compliance score.

18. The system of claim 17, wherein the first set of machine-readable instructions which causes the at least one computing device to calculate the compliance score further causes the at least one computing device to at least:
calculate a presence score;
calculate a completeness score;
calculate a correctness score; and
combine the presence score, the completeness score, and the correctness score to determine the compliance score.

19. The system of claim 15, wherein the first set of machine-readable instructions further causes the at least one computing device to at least:
calculate a health score based at least in part on a comparison of the health data; and
generate the scorecard based at least in part on the health score.

20. The system of claim 19, wherein the first set of machine-readable instructions, which causes the at least one computing device to calculate the health score, further causes the at least one computing device to at least:
compare the health data to tracing data for the application; and
calculate the health score based at least in part on a comparison of the health data and the tracing data.
